(19) United States
(12) Patent Application Publication
(10) Pub. No.: US 2011/0057471 A1
(43) Pub. Date: Mar. 10, 2011

(54) Wiser visor

(76) Inventor: Annie Lane, Upper Black Eddy, PA (US)

(21) Appl. No.: 12/806,875

(22) Filed: Aug. 23, 2010

Related U.S. Application Data
(60) Provisional application No. 61/274,807, filed on Aug. 21, 2009.

(51) Int. Cl. B60J 3/00

(52) U.S. Cl. 296/97.6

(57) ABSTRACT

The present invention provides a line of two-piece, automobile sun visors to block sun from both the front and side windows of an automobile manufactured of solid reinforced panels, or tinted optical glass material, designed to filter the sun's harmful ultraviolet rays. Similar in appearance to a standard automobile sun visor, the Wiser Visor is essentially rectangular in shape in the folded position and is manufactured in a variety of sizes appropriate for the various makes and models cars, vans and trucks on the road. These attractive sun visors are tinted in a variety of eye-catching colors to match the vehicle interior, as well as in a host of neutral hues. The Wiser Visor is manufactured for both the driver and passenger side of the car, with each visor featuring a hinged, heavy duty metal extension arm designed to be snap fitted to the to the interior roof of the automobile.

### CLAIM OF PRIORITY

This patent application claims priority under 35 USC 119(e)(1) from U.S. Provisional Patent Application Ser. No. 61/274,807 filed Aug. 21, 2009, of common inventorship herewith entitled, “Wiser Visor.”

### FIELD OF THE INVENTION

The present invention pertains to the field of automotive accessories, and more specifically to the field of sun visors for automobiles.

### BACKGROUND OF THE INVENTION

The present invention has put forth several variations on sun visors for automobiles. Among these are:

U.S. Pat. No. 4,792,177 to E. Gunnar Svensson describes a sun visor for a vehicle side window.

U.S. Pat. No. 4,844,530 to Gert Mahler, et al describes a sun visor for mounting above a side window in a vehicle.

U.S. Pat. No. 5,044,687 to Ibrahim K. Abu-Shumays et al describes a slidable sun visor for an automobile.

None of these prior art references describe the present invention.

### SUMMARY OF THE INVENTION

It is an object of the present invention to provide an improved sun visor for automobiles.

### BRIEF DESCRIPTION OF THE DRAWINGS

FIG. 1 is a perspective view of the improved sun visor of the present invention in the closed position.

FIG. 2 shows the improved sun visor of the present invention in use in an automobile in the “down in front” position.

FIG. 3 shows the improved sun visor of the present invention in use in an automobile in the “down in front” and in the side positions.

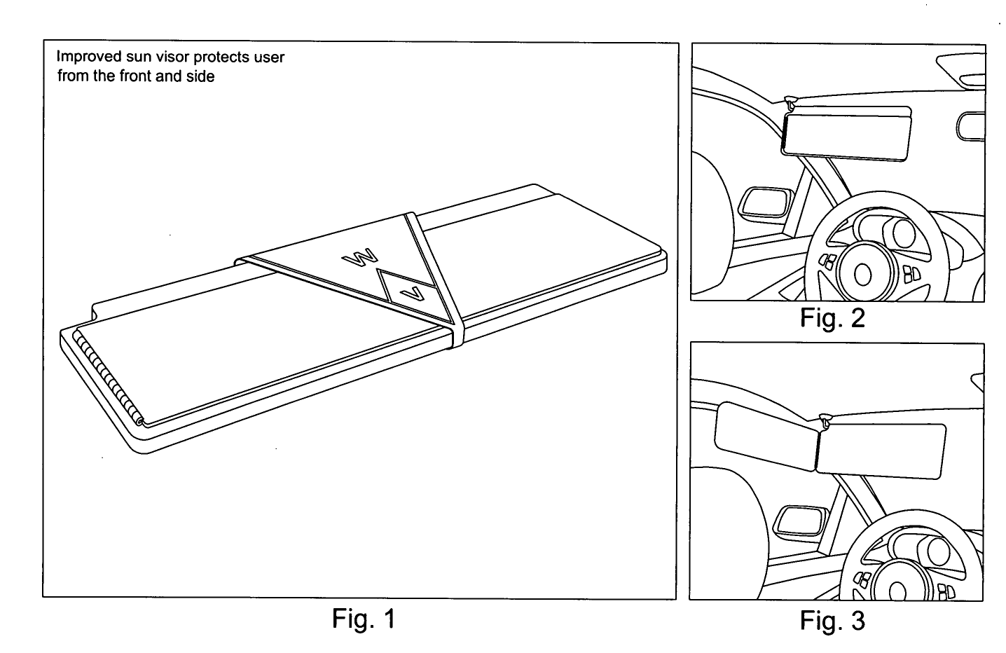

### DETAILED DESCRIPTION OF THE INVENTION

As many drivers would attest, driving in the direction of sunlight can be both difficult and dangerous. Causing unavoidable “blind spots”, the glare of intense sunlight can make it almost impossible to see the road ahead. Resulting in low-contrast vision, glare from the sun can be distracting and can directly affect driving comfort and safety. Burning the eyes and causing fatigue and strain, the blinding glare caused by ultraviolet rays can make even the shortest journeys exhausting and stressful. Most consumers attempt to solve this problem by utilizing a sun visor.

Sun visors are a standard feature in all cars and trucks and offer the driver a simple means of reducing glare and shading their eyes. Although sun visors are a practical accessory, they do little to combat the glare which enters the vehicle from the side door windows. Specifically, the intense glare from the sun that penetrates the driver or passenger side windows can be just as harmful as that which enters from the windshield. While pulling the sun visor to the side can block this glare, doing so results in light entering the vehicle through the front of the windshield, again, leaving the driver susceptible to the aforementioned dangers.

Recognizing the need for an automobile sun visor that adequately blocks the sun from both the windshield and side window, while enabling drivers and passengers to clearly see the road, the present invention, hereinafter referred to as the Wiser Visor, was developed. The Wiser Visor is a line of two-piece, automobile sun visors manufactured of solid reinforced panels, or tinted optical glass material, designed to filter the sun's harmful ultraviolet rays. Similar in appearance to a standard automobile sun visor, the Wiser Visor is essentially rectangular in shape in the folded position and is manufactured in a variety of sizes appropriate for the various makes and models cars, vans and trucks on the road. These attractive sun visors are tinted in a variety of eye-catching colors to match the vehicle interior, as well as in a host of neutral hues. The Wiser Visor is manufactured for both the driver and passenger side of the car, with each visor featuring a hinged, heavy duty metal extension arm designed to be snap fitted to the to the interior roof of the automobile.

The extension arm is positioned on the upper left corner of the driver's side Wiser Visor and on the upper right corner of the passenger's side visor.

In an alternative embodiment, the Wiser Visor can be configured to be secured to the bottom of the existing automobile visor via simple clip or clamp closure secured to the top of the unit.

The visors of the present invention comprise are two-piece units, with each visor boasting a “front” and “back” visor, with the two visors connected to one another via a series of small hinges that run along the outer edge of the unit, with one visor resting in front of the other when in the closed position. In this manner, the user opens both visors, pulling them both downwards and then swaying the front visor to the left or right in order to block the sun from the side window, while using the rear visor to block the sun from the windshield.

A self affixing hook and loop (more commonly referred to as Velcro™) fastener is positioned on the interior of the outer edge of the front visor and the front edge of the second visor respectively, thus holding the second visor closed when not in use. Both the driver and passenger side Wiser Visor are packaged and sold as a set, to be installed by the vehicle owner. Alternatively, the Wiser Visor can be included as an upgrade in newly manufactured automobiles.

Use of the Wiser Visor is very simple and straightforward. The consumer simply has the Wiser Visor professionally installed inside their vehicle by a service technician, or in the case of the skilled auto owner, they simply install the Wiser Visor themselves. To access the installed visors, the user simply pulls the double visors away from the ceiling of the car, positioning them in place in front of the windshield. The user then pulls the front visor to the side, blocking the light from their side window, while the rear visor reduces the glare of light coming in from the windshield. After use, the visors are closed until again needed.

The Wiser Visor is a unique invention which offers consumers many significant benefits and advantages. Foremost, this cleverly designed invention provides those driving or riding in the front seat of automobiles, a comfortable means of viewing the road. Two visors in one, the Wiser Visor eliminates the blinding glare caused by overhead sunlight from both the windshield and side window.

In this manner, use of the Wiser Visor ensures that the driver can safely see the road ahead, as well as oncoming traffic approaching from the side, even on the sunniest of afternoons. Blocking the sun's harmful ultraviolet rays, use of the Wiser Visor protects the eyes from potentially dangerous overexposure to the sun. Additionally, because the Wiser Visor effectively protects the eyes from glare and sunlight, use of this product greatly reduces the eye and body fatigue associated with heat and glare.

Although designed with the general consumer in mind, the Wiser Visor proves an invaluable accessory for those who drive professionally. City bus drivers, cabbies, truckers and delivery personnel will all appreciate the many benefits this useful invention affords. Durable, the Wiser Visor will withstand years of repeated use.

Reducing glare and blocking ultraviolet rays from front and side windows, the Wiser Visor is a practical invention which offers consumers a safe and comfortable means of driving in the sun. Simple to install, this unique product proves a valuable accessory for anyone who operates a motor vehicle. Affordably priced, the Wiser Visor will be well received by the countless consumers who own automobiles.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved sun visor for an automobile, comprising a foldable two-piece automobile sun visor manufactured of solid reinforced panels, or tinted optical glass material, essentially rectangular in shape in the folded position and is manufactured in a variety of sizes for the driver and passenger side of the car, with each visor comprising a hinged, heavy duty metal extension arm snap fitted to the to the interior roof of the automobile, and wherein the extension arm is positioned on the upper left corner of the driver's side of the visor on the upper right corner of the passenger's side visor.

2. An improved sun visor for an automobile wherein the visor is configured to be secured to the bottom of the existing automobile visor using a simple clip or clamp closure secured to the top of the unit.

3. An improved sun visor for an automobile comprising a two-piece units, each visor boasting a “front” and “back” visor, with the two visors connected to one another via a series of small hinges that run along the outer edge of the unit, with one visor resting in front of the other when in the closed position wherein the user opens both visors, pulling them both downwards and then swaying the front visor to the left or right in order to block the sun from the side window, while using the rear visor to block the sun from the windshield.

4. The improved sun visor for an automobile of claim 1 further comprising a self affixing hook and loop fastener positioned on the interior of the outer edge of the front visor and the front edge of the second visor respectively, thus holding the second visor closed when not in use.
